(19) United States
(12) Patent Application Publication
(10) Pub. No.: US 2010/0246018 A1
(43) Pub. Date: Sep. 30, 2010

(54) LENS HAVING ANTIREFLECTION AND LIGHT ABSORBING FILMS AND LENS ARRAY INCLUDING SUCH LENS

(75) Inventor: TAI-CHERNG YU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/556,781

(22) Filed: Sep. 10, 2009

(30) Foreign Application Priority Data
Mar. 24, 2009 (CN) 200910301084.1

(51) Int. Cl. G02B 5/22; G02B 1/11

(52) U.S. Cl. 359/614; 359/738

(57) ABSTRACT

An exemplary lens includes a light permeable substrate having a first surface and a second surface at opposite sides thereof, a first antireflection film formed at the first surface, a first optically active part formed on the first antireflection film, and a first light absorbing film formed on the first antireflection film around the first optically active part.

### BACKGROUND

1. Technical Field

The present disclosure relates to optical imaging, and particularly to a lens having an antireflection film and a light absorbing film, and a lens array including a plurality of such lenses.

2. Description of Related Art

Nowadays, camera modules are in widespread use in various kinds of electronic devices, such as digital cameras, cell phones, and the like.

A camera module typically includes a plurality of lenses and an image sensor. When light enters the camera module, the surfaces of the lenses may reflect a part of the light. Typically, all the surfaces of the lenses reflect a part of the light before the light reaches the image sensor. Some of the reflected light is further reflected and thus redirected to the image sensor. The cumulative effect of all such multiple reflections of light may cause flare on the image captured by the image sensor.

Therefore, a new lens means is desired to overcome the above-mentioned problems.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a top plan view of a lens array according to a first embodiment of the present disclosure.

FIG. 2 is a cross-sectional view of one lens of the lens array of FIG. 1.

FIGS. 3-9 are cross-sectional views showing successive stages of an exemplary method for making the lens array of FIG. 1.

### DETAILED DESCRIPTION

Embodiments will now be described in detail below with reference to the drawings.

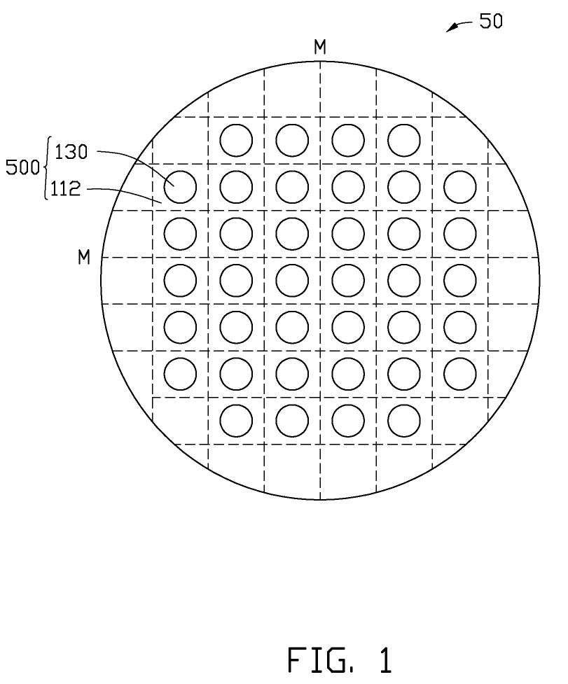

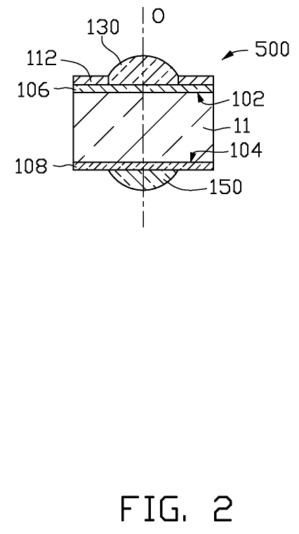

Referring to FIGS. 1 and 2, a lens array 50 and a lens 500 according to a first embodiment are shown. The lens array 50 includes a plurality of lenses 500 arranged in a matrix of rows and columns. The lens array 50 can be cut into a plurality of the individual lenses 500 along broken lines M.

The lens 500 includes a light permeable substrate 11 having a first surface 102 and a second surface 104 at opposite sides thereof, an antireflection film 106 formed on the first surface 102, a first optically active part 130 formed on the antireflection film 106, a light absorbing film 112 formed on the antireflection film 106 around the first optically active part 130, a filter film 108 formed on the second surface 104, and a second optically active part 150 formed on the filter film 108. The first and the second optically active parts 130, 150 share a same optical axis O. The first and the second optically active parts 130, 150 can be made of the same material or different materials.

The antireflection film 106 increases the proportion of incoming light transmitting from the first optically active part 130 which is able to enter the light permeable substrate 11 via the first surface 102. The light absorbing film 112 can be made of opaque material, for example, chromium. In a typical application of the lens 500, the lens 500 is coupled with other optical elements (not shown) located above the lens 500. When incoming light reaches the light absorbing film 112, the light absorbing film 112 absorbs the light, and accordingly, prevents the light from reflecting between the lens 500 and the other optical elements. Accordingly, image flare caused by multiple reflections can be reduced or even eliminated altogether. The filter film 108 can be an infrared-cut filter.

It is to be understood that in further or alternative embodiments, a filter film (not shown) can be sandwiched between the first surface 102 of the light permeable substrate 11 and the antireflection film 106. In the case where such filter film is an alternative embodiment, the second optically active part 150 can be formed directly on the second surface 104. In addition, in the case where the second optically active part 150 is formed directly on the second surface 104, a second light absorbing film can be formed on the second surface 104 around the second optically active part 150.

It is to be understood that in alternative embodiments, another antireflection film (not shown) can be arranged between the second surface 104 of the light permeable substrate 11 and the filter film 108.

It is to be understood that in other alternative embodiments, another light absorbing film (not shown) can be formed on the filter film 108 around the second optically active part 150.

It is to be understood that in various embodiments, either or both of the first and the second optically active parts 130, 150 can be concave lenses or convex lenses. In the illustrated embodiment, both the first and the second optically active parts 130, 150 are convex lenses.

The lens 500 can be made by the following exemplary method:

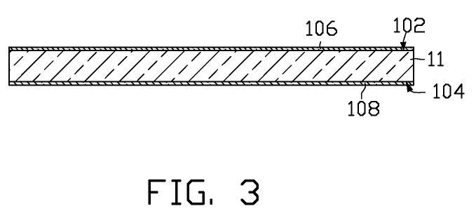

In step 1, referring to FIG. 3, a light permeable substrate 11 having a first surface 102 and a second surface 104 at opposite sides is provided.

In step 2, an antireflection film 106 is formed on the first surface 102, and a filter film 108 is applied on the second surface 104. The antireflection film 106 can be formed by, e.g., sputtering. The filter film 108 can be formed by, e.g., sputtering.

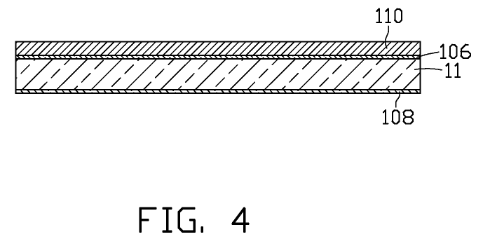

In step 3, referring to FIG. 4, a photoresist layer 110 is applied on the antireflection film 106 by, e.g., spin coating. In the present embodiment, the photoresist layer 110 is a positive photoresist layer. It should be noted that in other embodiments, the photoresist layer 110 can be a negative photoresist layer.

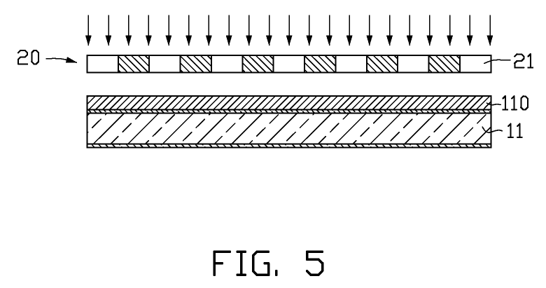

In step 4, referring to FIG. 5, a photomask 20 with a plurality of predetermined light pervious regions 21 is provided.

In step 5, the photomask 20 is positioned between the photoresist layer 110 and a light source (not shown). The light source emits light towards the photomask 20, and some of the light passes through the light pervious regions 21 and reaches the photoresist layer 110. As a result, parts of the photoresist layer 110 are exposed.

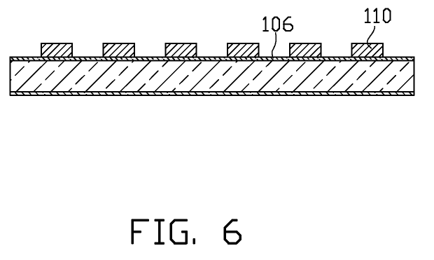

In step 6, referring to FIG. 6, the photoresist layer 110 is developed to remove the exposed parts of the photoresist layer 110 from the antireflection film 106. A developer such as AZ400K, can be used in this step.

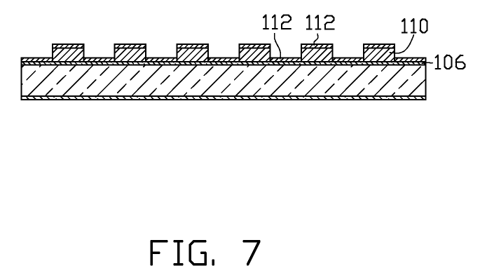

In step 7, referring to FIG. 7, a light absorbing film 112 is formed on surfaces of the antireflection film 106 and surfaces of the remaining photoresist layer 110. The light absorbing film 112 can be formed by sputtering.

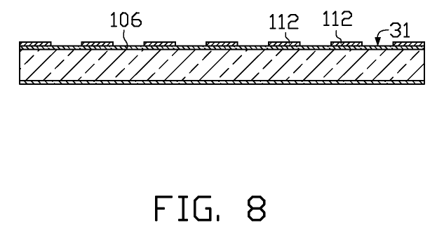

In step 8, referring to FIG. 8, the remaining photoresist layer 110 is removed from the antireflection film 106. This can be performed using, e.g., acetone organic solution. Accordingly, areas 31 of the antireflection film 106 are exposed.

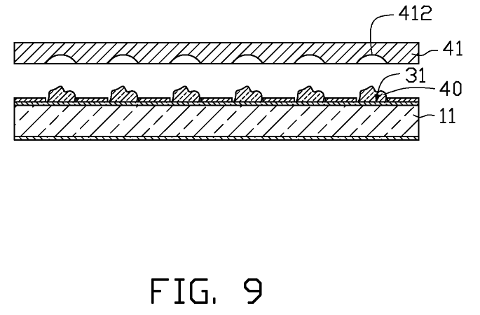

In step 9, referring to FIG. 9, blobs 40 of to-be-solidified optical material are applied on the areas 31 of the antireflection film 106. The optical material can be, for example, ultraviolet curable polymer.

In step 10, an imprinting mold 41 with a plurality of molding parts 412 is provided. The imprinting mold 41 is positioned in such a manner that each blob 40 faces and is aligned with a respective molding part 412. Then the imprinting mold 41 is pressed onto the light permeable substrate 11 subassembly such that the molding parts 412 press-mold the blobs 40.

In step 11, the press-molded blobs 40 are solidified by ultraviolet irradiation to form a plurality of first optically active parts 130, which are arranged in an array as seen in FIG. 1. Then, a plurality of second optically active parts 150 are formed on the filter film 108 by carrying out steps similar to steps 9, 10 and 11 described above. Thus the lens array 50 is obtained, as seen in FIG. 1. Each first optically active part 130 and the corresponding second optically active part 150 share a same optical axis O.

In step 12, referring to FIGS. 1-2, the lens array 50 is cut along the broken lines M to obtain a plurality of lenses 500, one of which is shown in FIG. 2.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope and spirit of the appended claims.

What is claimed is:

1. A lens comprising:
a light permeable substrate having a first surface and a second surface at opposite sides thereof;
a first antireflection film formed at the first surface;
a first optically active part formed on the first antireflection film; and
a first light absorbing film formed on the first antireflection film around the first optically active part.

2. The lens of claim 1, further comprising a filter film formed at the second surface.

3. The lens of claim 2, further comprising a second optically active part formed on the filter film.

4. The lens of claim 3, further comprising a second antireflection film formed on the second surface, the second antireflection film sandwiched between the second surface and the filter film.

5. The lens of claim 3, further comprising another filter film, which is formed on the first surface and is sandwiched between the first surface and the first antireflection film.

6. The lens of claim 3, further comprising a second light absorbing film formed on the filter film around the second optically active part.

7. The lens of claim 1, further comprising a filter film formed on the first surface, the filter film sandwiched between the first surface and the first antireflection film.

8. The lens of claim 7, further comprising a second optically active part formed on the second surface.

9. The lens of claim 8, further comprising a second light absorbing film formed on the second surface around the second optically active part.

10. A lens array comprising:
a light permeable substrate having a first surface and a second surface at opposite sides thereof;
a first antireflection film formed on the first surface of the light permeable substrate;
an array of first optically active parts formed on the first antireflection film, the first optically active parts separated from one another; and
a light absorbing film formed on the first antireflection film, each first optically active part being surrounded by the light absorbing film.

11. The lens array of claim 10, further comprising a filter film formed at the second surface of the light permeable substrate.

12. The lens array of claim 11, further comprising an array of second optically active parts formed on the filter film, wherein the second optically active parts are separated from one another.

13. The lens array of claim 12, further comprising a second antireflection film formed on the second surface, the second antireflection film sandwiched between the second surface and the filter film.

14. The lens array of claim 10, further comprising a filter film formed on the first surface, the filter film sandwiched between the first surface and the first antireflection film.

15. The lens array of claim 14, further comprising an array of second optically active parts formed on the second surface, wherein the second optically active parts are separated from one another.

16. The lens array of claim 15, further comprising a second light absorbing film formed on the second surface.
